(19) United States
(12) Patent Application Publication
(10) Pub. No.: US 2019/0037873 A1
(43) Pub. Date: Feb. 7, 2019

(54) METHOD FOR PREPARING COFFEE CREAM

(71) Applicant: SHANGHAI HI-ROAD FOOD TECHNOLOGY CO., LTD., Shanghai (CN)

(72) Inventor: Haihu HUANG, Shanghai (CN)

(73) Assignee: SHANGHAI HI-ROAD FOOD TECHNOLOGY CO., LTD., Shanghai (CN)

(21) Appl. No.: 16/075,651

(22) PCT Filed: Nov. 28, 2016
(86) PCT No.: PCT/CN2016/107568

§ 371 Date: Aug. 4, 2018

(30) Foreign Application Priority Data
Mar. 27, 2016 (CN) 201610181632.1

(51) Int. Cl. A23D 7/005; A23D 7/04; A23C 13/12; A23F 5/36

(52) U.S. Cl. CPC A23D 7/0053; A23F 5/36; A23C 13/12; A23D 7/04

(57) ABSTRACT

The present invention discloses a method for preparing coffee cream, comprising the following steps: (1) preparing oil phase; (2) preparing aqueous phase; (3) add aqueous phase to the oil phase to mix them, stir evenly and perform sterilization; (4) dissolve coffee extract in 40-70° C. water and perform sterilization; (5) add the sterilized aqueous solution of the coffee extract to the sterilized oil-water mixture, stir evenly and homogenize; (6) stir the homogenized material at a temperature of below 10° C. for 1 hour at a low speed, then perform filling, and preserve under a frozen condition below −18° C. Compared with traditional technology, the present invention has the following advantages. The present invention improves the process conditions, adjusts feeding sequence of components. After the coffee powder is sterilized alone, it is mixed with the sterilized water-oil phase. By this process, it solves the problem of damage of surface tension. The cream made by this process, after whipping, has smooth surface and no pores, with stable foam structure, good operability, high whipping rate and pure and long-lasting favor. The products made have good freeze-thaw stability.

### TECHNICAL FIELD

The present invention relates to a cream product technical field, and in particular to a method for preparing a coffee cream.

### BACKGROUND ART

Currently, there are no coffee cream products available on the markets. Usually the existing product is mixture of coffee and light cream, which may cause the problem of uneven mixing and restriction on the whipping ability of cream. In addition, there are similar products obtained by flavors and fragrances on the markets, but coffee cream products made by pure coffee extracts are not available yet.

According to the needs of bakery products, the coffee creams with good operability, high stability and high whipping rate have extensive market prospects. The conventional method for making cream is to mix the coffee extracts and water-oil phase mixture and pasteurize, and then homogenize to obtain liquid coffee cream. However, during the whipping process, the coffee cream prepared by this process will produce a large number of pores, which are unsmooth and restricted on the whipping ability. It cannot form a stable foam structure, and the whipping rate and stability of cream is not good.

In the non-dairy cream system, if the water-oil system is more stable, the cream will not be easily gathered when whipping, so it is not easy to form a stable foam structure. On the contrary, if the water-oil system is unstable, it will cause the oil-water separation during preparation and storage of cream, and it is unable to form stable foam structure during whipping, seriously affecting the product quality. Therefore, under normal circumstances, the non-dairy cream system needs to be in a metastable state. The stability of the system is affected by many raw materials. Different raw materials and their delivery technologies have a significant influence on the stability of the products. In order to improve the quality of coffee cream, the present invention uses natural coffee powder as a raw material to make coffee cream, and the addition of coffee powder will damage the surface tension of the cream. Therefore, the present invention improves the process, to separate the coffee powder from other materials and sterilize them, and then mix them, so as to solve the problem of damage of cream surface tension effectively. For the cream made by this process, after whipping, its surface is smooth and non- porous. Compared with the coffee cream prepared by the traditional process, its operatability, stability and whipping rate are significantly improved, and the flavor can be maintained long. This process solves the drawbacks of traditional preparation methods and provides a stable and high-quality specialty coffee cream.

### SUMMARY OF THE INVENTION

An object of the present invention is to solve the aforesaid problem and provide a method for preparing coffee cream.

To achieve the object, the present invention adopts the following technical solutions.

A method for preparing a coffee cream, comprising the following steps:
(1) Preparing oil phase: Melt and heat vegetable oil to 60-65° C., add sorbitan monostearate, lecithin, lactate monoglyceride, sodium stearoyl lactylate, polyglycerol ester, microcrystalline cellulose, modified cellulose, sodium caseinate, and potassium dihydrogen phosphate; stir to disperse the components evenly to obtain an oil-phase mixture;
(2) Preparing aqueous phase: Dissolve sugar and syrup in water at 65-70° C. to obtain an aqueous-phase mixture;
(3) Add aqueous phase to the oil phase to mix them, stir evenly and perform sterilization;
(4) Dissolve coffee extract in 40-70° C. water and perform sterilization;
(5) Add the sterilized aqueous solution of the coffee extract to the sterilized oil-water mixture, stir evenly and homogenize;
(6) Stir the homogenized material at a temperature of below 10° C. for 1 hour at a low speed, then perform filling, and preserve under a frozen condition below −18° C.

Compared with traditional cream making technology, the present invention has the following advantages. The present invention improves the process conditions, adjusts feeding sequence of components. After the coffee powder is sterilized alone, it is mixed with the sterilized water-oil phase. By this process, it solves the problem of damage of surface tension. The cream made by this process, after whipping, has smooth surface and no pores, with stable foam structure, good operability, high whipping rate and pure and long-lasting favor. The products made have good freeze-thaw stability.

### DETAILED DESCRIPTIONS

### Example 1

Weigh palm kernel oil 240 g, sorbitan monostearate 3.5 g, lecithin 2.0 g, lactate monoglyceridel 1.2 g, sodium stearoyl lactylate 2.5 g, polyglycerol ester 1.2 g, microcrystalline cellulose 3.0 g, modified cellulose2.3 g, sodium caseinate 6.8 g, potassium dihydrogen phosphate 1.5 g, sugar 133 g, glucose syrup 79 g, coffee extract 17 g, and water 507g.

### Preparation Process

(1) Preparing oil phase: Melt and heat vegetable oil to 60-65° C., add sorbitan monostearate, lecithin, lactate monoglyceride, sodium stearoyl lactylate, polyglycerol ester, microcrystalline cellulose, modified cellulose, sodium caseinate, and potassium dihydrogen phosphate; stir to disperse evenly to obtain an oil-phase mixture;

(2) Preparing aqueous phase: Dissolve sugar and syrup in water at 65-70° C. to obtain an aqueous-phase mixture;

(3) Add aqueous phase to the oil phase to mix them, stir evenly and perform sterilization;

(4) Dissolve coffee extract in 40-70° C. water and perform sterilization;

(5) Add the sterilized aqueous solution of the coffee extract to the sterilized oil-water mixture, stir evenly and homogenize;

(6) Stir the homogenized material at a temperature of below 10° C. for 1 hour at a low speed, then perform filling, and preserve under a frozen condition below -18° C.

The results of test of performance indices of coffee cream products made by this process are shown in Table 1.

TABLE 1

| Performance indices | Result |
|---|---|
| Whipping time | 6 minutes |
| Whipping rate | 4.3 |
| Cream appearance | The surface is smooth and non-porous, with good |
| after whipping | stiffness. |
| Stability | The foam structure is stable and its thermal |
| | stability is good. |
| Operability | The cream is very operable after whipping. |
| Freeze-thaw stability | Repeatedly thaw 5 times, no significant changes |
| | in product performance, and good freeze-thaw |
| | stability. |
| Taste flavor | The coffee flavor is pure and long-lasting, and |
| | cream is immediately melted when eating, with |
| | good taste. |

### Example 2

Weigh palm kernel oil 233 g, sorbitan monostearate 4.5 g, lecithin 1.5 g, lactate monoglyceridel 1.5 g, sodium stearoyl lactylate 2.9 g, polyglycerol ester 0.8 g, microcrystalline cellulose 3.4 g, modified cellulose 2.2 g, sodium caseinate 6.8 g, potassium dihydrogen phosphate 1.5 g, sugar 125 g, glucose syrup 72 g, coffee extract 16 g, and water 528.9g.

### Preparation Process

(1) Preparing oil phase: Melt and heat vegetable oil to 60-65° C., add sorbitan monostearate, lecithin, lactate monoglyceride, sodium stearoyl lactylate, polyglycerol ester, microcrystalline cellulose, modified cellulose, sodium caseinate, and potassium dihydrogen phosphate; stir to disperse evenly to obtain an oil-phase mixture;

(2) Preparing aqueous phase: Dissolve sugar and syrup in water at 65-70° C. to obtain an aqueous-phase mixture;

(3) Add aqueous phase to the oil phase to mix them, stir evenly and perform sterilization;

(4) Dissolve coffee extract in 40-70° C. water and perform sterilization;

(5) Add the sterilized aqueous solution of the coffee extract to the sterilized oil-water mixture, stir evenly and homogenize;

(6) Stir the homogenized material at a temperature of below 10° C. for 1 hour at a low speed, then perform filling, and preserve under a frozen condition below −18° C.

The results of test of performance indices of coffee cream products made by this process are shown in Table 2.

TABLE 2

| Performance indices | Result |
|---|---|
| Whipping time | 5 minutes and 30 seconds |
| Whipping rate | 4.4 |
| Cream appearance | The surface is smooth and non-porous, with |
| after whipping | good stiffness. |
| Stability | The foam structure is stable and its thermal |
| | stability is good. |
| Operability | The cream is very operable after whipping. |
| Freeze-thaw stability | Repeatedly thaw 5 times, no significant changes |
| | in product performance, and good freeze-thaw |
| | stability. |
| Taste flavor | The coffee flavor is pure and long-lasting, and |
| | cream is immediately melted when eating, with |
| | good taste. |

### Example 3

Weigh palm kernel oil 237.6 g, sorbitan monostearate 4.5 g, lecithin 2.5 g, lactate monoglyceridel 2 g, sodium stearoyl lactylate 2.5 g, polyglycerol ester 1.4 g, microcrystalline cellulose 2.8 g, modified cellulose 2.4 g, sodium caseinate 6.8 g, potassium dihydrogen phosphate 1.5 g, sugar 120 g, glucose syrup 75 g, coffee extract 16 g, and water 525g.

Preparation process:

(1) Preparing oil phase: Melt and heat vegetable oil to 60-65° C., add sorbitan monostearate, lecithin, lactate monoglyceride, sodium stearoyl lactylate, polyglycerol ester, microcrystalline cellulose, modified cellulose, sodium caseinate, and potassium dihydrogen phosphate, stir to disperse evenly, to obtain an oil-phase mixture;

(2) Preparing aqueous phase: Dissolve sugar and syrup in water at 65-70° C. to obtain an aqueous-phase mixture;

(3) Add aqueous phase to the oil phase to mix them, stir evenly and perform sterilization;

(4) Dissolve coffee extract in 40-70° C. water and perform sterilization;

(5) Add the sterilized aqueous solution of the coffee extract to the sterilized oil-water mixture, stir evenly and homogenize;

(6) Stir the homogenized material at a temperature of below 10° C. for 1 hour at a low speed, then perform filling, and preserve under a frozen condition below −18° C.

The results of test of performance indices of coffee cream products made by this process are shown in Table 3.

TABLE 3

| Performance indices | Result |
|---|---|
| Whipping time | 5 minutes and 45 seconds |
| Whipping rate | 4.3 |
| Cream appearance | The surface is smooth and non-porous, with good |
| after whipping | stiffness. |
| Stability | The foam structure is stable and its thermal |
| | stability is good. |
| Operability | The cream is very operable after whipping. |
| Freeze-thaw stability | Repeatedly thaw 5 times, no significant changes |
| | in product performance, and good freeze-thaw |
| | stability. |
| Taste flavor | The coffee flavor is pure and long-lasting, and |
| | cream is immediately melted when eating, with |
| | good taste. |

### Comparative Example

### Process

Weigh palm kernel oil 240 g, sorbitan monostearate 3.5 g, lecithin 2.0 g, lactate monoglyceridel 1.2 g, sodium stearoyl lactylate 2.5 g, polyglycerol ester 1.2 g, microcrystalline cellulose 3.0 g, modified cellulose 2.3 g, sodium caseinate 6.8 g, potassium dihydrogen phosphate 1.5 g, sugar 133 g, glucose syrup 79 g, coffee extract 17 g, and water 507g.

### Preparation Process

(1) Preparing oil phase: Melt and heat vegetable oil to 60-65° C., add sorbitan monostearate, lecithin, lactate monoglyceride, sodium stearoyl lactylate, polyglycerol ester, microcrystalline cellulose, modified cellulose, sodium caseinate, and potassium dihydrogen phosphate; stir to disperse evenly to obtain an oil-phase mixture;

(2) Preparing aqueous phase: Dissolve sugar and syrup in water at 65-70° C. to obtain an aqueous-phase mixture;

(3) Add aqueous phase to the oil phase to mix them, stir evenly and perform sterilization;

(4) Dissolve coffee extract in 40-70° C. water and perform sterilization;

(5) Add the sterilized aqueous solution of the coffee extract to the sterilized oil-water mixture, stir evenly and homogenize;

(6) Stir the homogenized material at a temperature of below 10° C. for 1 hour at a low speed, then perform filling, and preserve under a frozen condition below −18° C.

### COMPARATIVE EXAMPLE 1

Weigh palm kernel oil 240 g, sorbitan monostearate 3.5 g, lecithin 2.0 g, lactate monoglyceridel 1.2 g, sodium stearoyl lactylate 2.5 g, polyglycerol ester 1.2 g, microcrystalline cellulose 3.0 g, modified cellulose 2.3 g, sodium caseinate 6.8 g, potassium dihydrogen phosphate 1.5 g, sugar 133 g, glucose syrup 79 g, coffee extract 17 g, and water 507g.

### Preparation Process

(1) Preparing oil phase: Melt and heat vegetable oil to 60-65° C., add sorbitan monostearate, lecithin, lactate monoglyceride, sodium stearoyl lactylate, polyglycerol ester, microcrystalline cellulose, modified cellulose, sodium caseinate, and potassium dihydrogen phosphate, stir to disperse evenly, to obtain an oil-phase mixture;

(2) Preparing aqueous phase: Dissolve sugar and syrup in water at 65-70° C. to obtain an aqueous-phase mixture;

(3) Add aqueous phase to the oil phase to mix them, stir evenly and perform sterilization;

(4) Dissolve coffee extract in 40-70° C. water and perform sterilization;

(5) Add the sterilized aqueous solution of the coffee extract to the sterilized oil-water mixture, stir evenly and homogenize;

(6) Stir the homogenized material at a temperature of below 10° C. for 1 hour at a low speed, then perform filling, and preserve under a frozen condition below −18° C.

By comparing the cream products made by two processes in the comparative embodiment 1 and comparative embodiment 2, the results are shown in Table 4.

TABLE 4
Performance test results of coffee creams made by processes in the Example 1 of
the present invention and the comparative Example 1

| | Test Object | |
|---|---|---|
| | Coffee cream made in | Coffee cream made in |
| Test Item | Example 1 of the invention | comparative Example 1 |
| Whipping time | 6 minutes | 7 minutes |
| Whipping rate | 4.3 | 3.6 |
| Cream appearance after | The surface is smooth and non- | The surface has many pores, |
| whipping | porous, with good stiffness. | with poor stiffness. |
| Stability | The foam structure is stable and | The foam structure is unstable |
| | its thermal stability is good. | and its thermal stability is |
| | | poor. |
| Operability | The cream is very operable | Poor operability |
| | after whipping. | |
| Freeze-thaw stability | Repeatedly thaw 5 times, no | The product performance |
| | significant changes in product | shows significant changes |
| | performance, and good freeze- | after thawing 3 times |
| | thaw stability. | repeatedly, and the operability |
| | | is poor and the freeze-thaw |
| | | stability is poor after |
| | | whipping. |
| Taste flavor | The coffee flavor is pure and | Have coarse sense when eating |
| | long-lasting, and cream is | cream, and the taste is worse. |
| | immediately melted when | |
| | eating, with good taste. | |

According to the comparison results in Table 1, the coffee cream made by the process in the present invention has excellent performance in all aspects, and compared with the coffee cream obtained by the traditional process, after whipping, the surface of the coffee cream is smooth and non-porous, with good stiffness, high whipping rate, high operability, stable foam structure and excellent thermal stability, pure flavor and good taste. In addition, its freeze-thaw stability has been significantly improved, to overcome the effect of repeated thawing on the product quality during the transportation. The preparation method of the invention has solved the drawbacks of the traditional preparation method, and it can provide a characteristic coffee cream with good stability and high quality.

What is claimed is:

1. A method for preparing a coffee cream, comprising the following steps:
(1) preparing an oil phase: melting and heating a vegetable oil to 60-65° C., adding sorbitan monostearate, lecithin, lactate monoglyceride, sodium stearoyl lactylate, polyglycerol ester, microcrystalline cellulose, modified cellulose, sodium caseinate, and potassium dihydrogen phosphate, stirring to disperse evenly to obtain the oil phase;
(2) preparing an aqueous phase: dissolving sugar and syrup in water at 65-70° C. to obtain the aqueous phase;
(3) adding the aqueous phase to the oil phase to mix them, stirring evenly, and performing sterilization;
(4) dissolving a coffee extract in 40-70° C. water and performing sterilization;
(5) adding sterilized aqueous solution of the coffee extract to sterilized oil-water mixture, stirring evenly, and homogenizing;
(6) stirring the homogenized material at a temperature below 10° C. for 1 hour at a low speed, then performing filling, and preserving under a frozen condition below −18° C.
